(19) United States
(12) Patent Application Publication
(10) Pub. No.: US 2013/0110904 A1
(43) Pub. Date: May 2, 2013

(54) METHOD AND APPARATUS TO FORWARD SHARED FILE STORED IN BLOCK STORAGES

(71) Applicant: Hideki OKITA, Sunnyvale, CA (US)

(72) Inventor: Hideki OKITA, Sunnyvale, CA (US)

(73) Assignee: HITACHI, LTD., Tokyo (JP)

(21) Appl. No.: 13/282,863

(22) Filed: Oct. 27, 2011

(51) Int. Cl. G06F 15/16

(52) U.S. Cl. 709/203

(57) ABSTRACT

In accordance with an aspect of the invention, a system comprises: a plurality of first nodes having an interface to receive via fibre channel protocol; a plurality of second nodes having an interface to receive via file access protocol; a layout management server which upon receiving from a client a write request containing file data to be written to any of the plurality of first and second nodes, returns to the client, information of location of data for the write request; and a gateway coupled to the plurality of first nodes and second nodes. The gateway converts access from file access protocol to fibre channel protocol so that a client issuing write requests in file access protocol is able to write file data to the plurality of first nodes via the gateway.

### BACKGROUND OF THE INVENTION

The present invention relates generally to network file sharing system and, more particularly, to a method and an apparatus to transfer shared files to clients.

In recent years, the network file system has become utilized to share business data, including business documents that are created and saved as electronic files. The network file system has a client-server architecture. Clients of the system send requests to a file server and receive file data as the response of the requests, and then assemble a file from the received data. To improve the performance of the network file system, distributed file system extends the architecture of the network file system. Such extended architecture has multiple file servers that have distributed file data and management server that manages the location of the distributed file data. In this system, a client sends multiple requests in parallel to the multiple file servers. These multiple accesses multiply the throughput of file access according to the number of file servers. Additionally, several distributed file systems have the architecture that its data path and control path are separated. On the control path, clients receive the information about the location of file data. This architecture realizes to change a file access protocol such as Network File System (NFS) to the different protocol for data path such as Fibre-Channel (FC). The clients can access distributed file data stored in block storages with FC protocol. It improves further the data transfer rate in the distributed file system.

However, when multiple different file access protocols, such as NFS and FC, are used in a network, the access area of each client may differ from the access area of others. That is because host adapters of each client are not the same among all clients. Normally, the number of clients equipped with FC host bus adaptor (HBA) is lower than the number of clients with network interface card (NIC). In such a case, the clients with NIC cannot access the file data stored in FC storages, and therefore have smaller access area than the area that the clients with FC-HBA can access.

U.S. Pat. No. 7,933,921 discloses a distributed file system that includes multiple storages of block device. The system has a previously described problem that clients without FC-HBA cannot access the files on the block storages. In RFC 5661 (Spencer Shepler et al., Network File System (NFS) Version 4.1, Internet Engineering Task Force (IETF), January 2010), a standard protocol named “parallel NFS (pNFS)” is used to transfer layouts of file data stored in one or multiple data servers from a layout management server named meta-data server to clients. The clients access the file data with NFS protocol or FC protocol according to the type of host adaptors with which they are equipped. The pNFS compliant system has a problem that clients without FC-HBA cannot access files on the block storages.

### BRIEF SUMMARY OF THE INVENTION

Exemplary embodiments of the invention provide a layout management server and a gateway that provide access to a file, in response to a request from a client, by file access protocol based on file data stored in block storages.

In a first embodiment, a novel layout management server stores layout information including a block layout about a file. The layout information also includes a pseudo file layout about the same file. The pseudo layout indicates that a client can get the file from a novel gateway by file access protocol. The gateway that receives the access from the client retrieves block layouts about file data stored in block storages for the specified file. It then reads the file data from the block storages and creates a file based on the file data. Finally, it sends the file to the client as a response.

In a second embodiment, a novel layout management server stores layout information including a block layout about a file. The layout information also includes a pseudo file layout about the same file. The pseudo layout indicates that a client without FC-HBA can get the file from another client equipped with FC-HBA by file access protocol. The latter client that receives the access from the former client retrieves block layouts about file data stored in block storages for the specified file. It then reads the file data from the block storages and creates a file based on the file data. Finally, it sends the file to the former client as a response.

In a third embodiment, a novel layout management server stores layout information including a block layout about a file. The layout information also includes a pseudo layout about the same file. The pseudo layout indicates that a client without FC-HBA can get the file from a novel layout management server which is equipped with FC-HBA by file access protocol. The layout management server that receives the access from the client retrieves block layouts about file data stored in block storages for the specified file. It then reads the file data from the block storages and creates a file based on the file data. Finally, it sends the file to the client as a response.

In accordance with an aspect of the present invention, a system comprises: a plurality of first nodes having an interface to receive via fibre channel protocol; a plurality of second nodes having an interface to receive via file access protocol; a layout management server which upon receiving from a client a write request containing file data to be written to any of the plurality of first and second nodes, returns to the client, information of location of data for the write request; and a gateway coupled to the plurality of first nodes and second nodes. The gateway converts access from file access protocol to fibre channel protocol so that a client issuing write requests in file access protocol is able to write file data to the plurality of first nodes via the gateway.

In some embodiments, the gateway, in response to receiving an access to the plurality of first nodes by file access protocol, sends a request for layout information to the layout management server, and converts the access from file access protocol to fiber channel protocol using the layout information from the layout management server. The layout information includes, for each layout regarding a file, a file name, a file handle, a layout type, and an identification of a target device. The layout management server sends the layout information to the gateway in response to the request from the gateway. The target device is the gateway indicating access to the plurality of first nodes by file access protocol, and the gateway creates layout information for the access to the plurality of first nodes by file access protocol. Access to the plurality of first nodes has an original BLOCK layout which includes a BLOCK layout type and identification of at least one first node as the target device. The layout management server creates a pseudo FILE layout having the same file handle as the original BLOCK layout, a FILES layout type, and identification of the gateway as the target device, thereby indicating a conversion from file access protocol to fibre channel protocol to access the target device of the original block layout via the gateway. The layout information includes both the original BLOCK layout and the pseudo FILE layout.

In accordance with another aspect of the invention, a system comprises: a plurality of first nodes having an interface to receive via fibre channel protocol; a plurality of second nodes having an interface to receive via file access protocol; and a layout management server coupled to the plurality of first nodes and second nodes, and which, upon receiving from a client a write request containing file data to be written to any of the plurality of first and second nodes, returns to the client, information of location of data for the write request. The layout management server converts access from file access protocol to fibre channel protocol so that a client issuing write requests in file access protocol is able to write file data to the plurality of first nodes via the layout management server.

In some embodiments, the layout management server converts the access from file access protocol to fiber channel protocol using layout information. The layout information includes, for each layout regarding a file, a file name, a file handle, a layout type, and an identification of a target device. The target device is set as the layout management server indicating access to the plurality of first nodes by file access protocol.

In accordance with another aspect of this invention, a system comprises: a plurality of host computers; a plurality of first nodes having an interface to receive via fibre channel protocol; a plurality of second nodes having an interface to receive via file access protocol; and a layout management server which upon receiving from any one of the host computers a write request containing file data to be written to any of the plurality of first and second nodes, returns to the one host computer, information of location of data for the write request. A first host computer of the plurality of host computer converts access from file access protocol to fibre channel protocol so that a second host computer of the plurality of host computers issuing write requests in file access protocol is able to write file data to the plurality of first nodes via the first host computer.

In some embodiments, the first host computer, in response to receiving an access to the plurality of first nodes by file access protocol, sends a request for layout information to the layout management server, and converts the access from file access protocol to fiber channel protocol using the layout information from the layout management server. The layout information includes, for each layout regarding a file, a file name, a file handle, a layout type, and an identification of a target device. The layout management server sends the layout information to the first host computer in response to the request from the first host computer. The target device is the first host computer indicating access to the plurality of first nodes by file access protocol, and the first host computer creates layout information for the access to the plurality of first nodes by file access protocol. The second host computer is incapable of access via fibre channel protocol.

These and other features and advantages of the present invention will become apparent to those of ordinary skill in the art in view of the following detailed description of the specific embodiments.

### BRIEF DESCRIPTION OF THE DRAWINGS

FIG. 1 shows an example of a network file system including a novel layout management server and a novel gateway according to the first embodiment.

FIG. 2 shows an example of the gateway of FIG. 1.

FIG. 3 shows an example of the layout management server of FIG. 1.

FIG. 4 shows an example of a pNFS client, which is equipped with FC-HBA and is connected to FC-SAN.

FIG. 5 shows an example of the pNFS client, which is equipped with NIC that is connected to the IP-LAN and does not have FC-HBA.

FIG. 6 shows an example of the meta-data server address information of the gateway.

FIG. 7 shows an example of the layout information of the layout management server.

FIG. 8 shows an example of the file device information.

FIG. 9 shows an example of the block device information.

FIG. 10 shows an example of message sequence between a pNFS client, the layout management server, and NFS servers according to the first embodiment.

FIG. 11 shows an example of a layout message from the layout management server as the response to the LAYOUTGET message from the pNFS client.

FIG. 12 shows an example of the message sequence according to the first embodiment of the present invention, including the layout management server and the gateway.

FIG. 13 shows an example of the message sequence which follows the message sequence of FIG. 12, according to the first embodiment.

FIG. 14 shows an example of a layout sent to the pNFS client from the layout management server.

FIG. 15 shows an example of a layout sent to the gateway from the layout management server.

FIG. 16 shows an example of a flow diagram illustrating the process of the LAYOUTGET message process program of the layout management server.

FIG. 17 shows an example of a flow diagram illustrating the process of the pNFS file request forward program of the gateway.

FIG. 18 shows an example of a network file system including a novel layout management server and a novel gateway embedded in a pNFS client according to the second embodiment.

FIG. 19 shows an example of the gateway of FIG. 18.

FIG. 20 shows an example of the message sequence according to the second embodiment of the present invention, including the layout management server and the gateway.

FIG. 21 shows an example of the message sequence which follows the message sequence of FIG. 20.

FIG. 22 shows an example of a network file system including a novel layout management server that acts as the novel gateway according to the third embodiment.

FIG. 23 shows an example of the combined server of FIG. 22.

FIG. 24 shows an example of the layout information of the combined server according to the third embodiment.

FIG. 25 shows an example of the message sequence according to the third embodiment of the present invention, including the combined server.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for transferring shared files to clients.

### First Embodiment

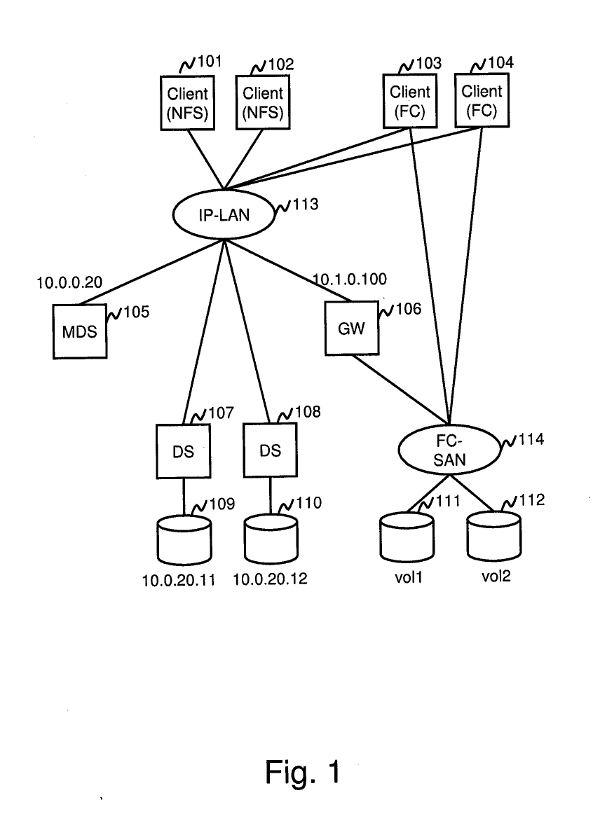

FIG. 1 shows an example of a network file system including a novel layout management server 105 and a novel gateway 106 according to the first embodiment. This system also includes multiple NFS clients 101 and 102, and multiple clients 103 and 104 equipped with both of NIC and FC-HBA. These clients 101-104, the layout management server 105, and the gateway 106 are connected with each other via an IP-LAN 113. The system also includes data servers 107 and 108 that support NFS access via the IP-LAN 113 to get file data directly from attached storage 109 and 110 respectively. It also includes multiple block storages 111 and 112 connected to the clients 103, 104, and the gateway 106 via a FC-SAN 114.

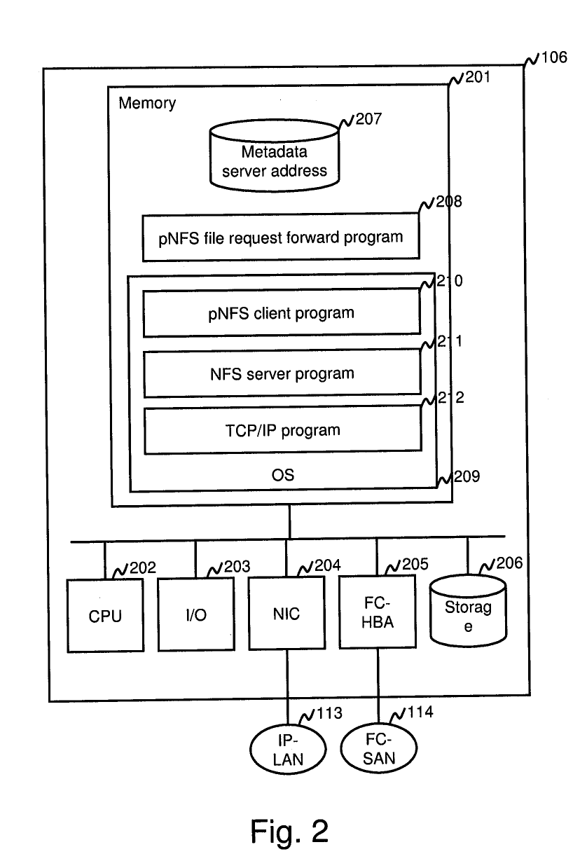

FIG. 2 shows an example of the gateway 106 of FIG. 1. It has memory 201, CPU 202, I/O 203, NIC 204 connected to the IP-LAN 113, FC-HBA 205 connected to the FC-SAN 114, and internal storage 206. These components are connected with each other via an internal bus. The memory 201 stores meta-data server address information 207 and stores a pNFS file request forward program 208 to be executed by the CPU 202. The meta-data server address information 207 stores the IP addresses of the layout management server 105. The program 208 receives NFS READ operation request from the client 101, and based on the request, it retrieves a block layout from the layout management server 105 and collects file data from the block storages 111 and 112. It transfers a file made from the collected file data to the client 101. The meta-data server address information 207 and the pNFS file request forward program 208 are newly developed components to realize the invention. The memory 201 also stores the following programs to be executed: an OS 209 including pNFS client program 210, NFS server program 211, and TCP/IP program 212, which are existing technologies.

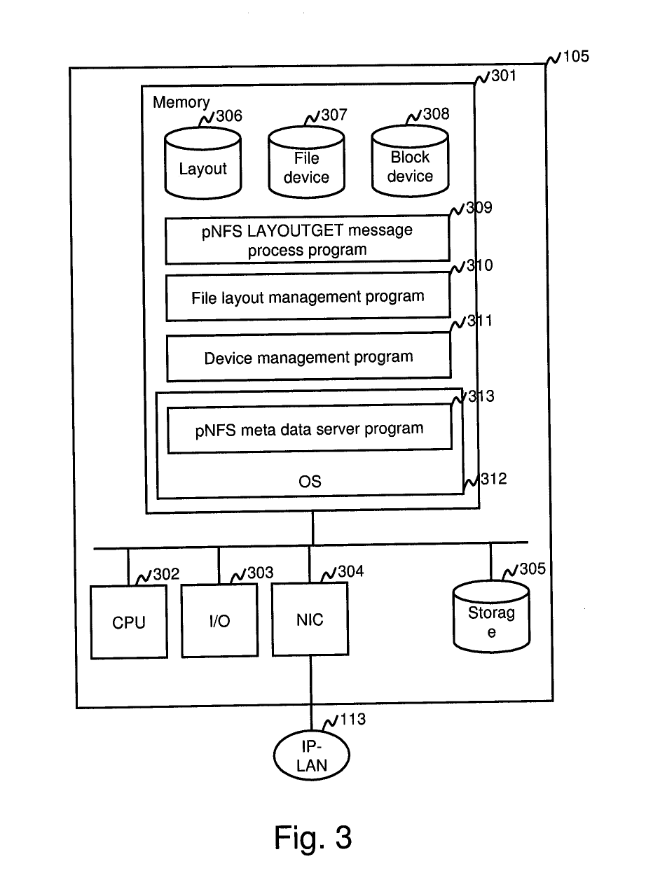

FIG. 3 shows an example of the layout management server 105 of FIG. 1. It has memory 301, CPU 302, I/O 303, NIC 304 connected to the IP-LAN 113, and internal storage 305. These components are connected with each other via an internal bus. The memory 301 stores hybrid layout information 306, file device information 307, and block device information 308. The layout information 306 stores real block layouts and pseudo file layouts. The file device information 308 stores the details about addresses of the NFS data servers 107 and 108. The block device information stores the details about the addresses of the FC block storages 111 and 112.

The layout management server 105 also executes a pNFS LAYOUTGET message process program 309 and a file layout management program 310 on the memory 301. The pNFS LAYOUTGET message process program 309 analyzes a LAYOUTGET message and selects an appropriate layout from the layouts stored in the layout information 306 according to the layout type specified in the LAYOUTGET message. The file layout management program 310 creates the pseudo file layout in the layout information 306 based on the real block layout. The created pseudo file layout entry has the same file handle as the original block layout, a FILES layout type, an address of the gateway 106 as a device ID, and the file handle of the original block layout as the value of a file handle list. The file layout management program 310 creates this pseudo layout either when the corresponding block layout is created or when a system administrator operates via a user interface of the layout management server 105. This process is a characteristic of the layout management server 105. Furthermore, sets of the original block layout and the corresponding pseudo file layout are characteristic of the layout management server 105.

The layout management server 105 also includes a device management program 311 on the memory 301. The device management program 311 manages the file device information 307 and the block device information 308. As a file server or block storage is added to or removed from the shared file system, the device management program 311 adds or removes an entry in that information.

The layout management server 105 also includes in the memory 301 an OS 312 and a pNFS meta-data server program 313 in the OS 312. This program 313 works as an underlying stack of the pNFS LAYOUTGET message process program 309 and forwards to it LAYOUTGET messages extracted from received pNFS operation messages.

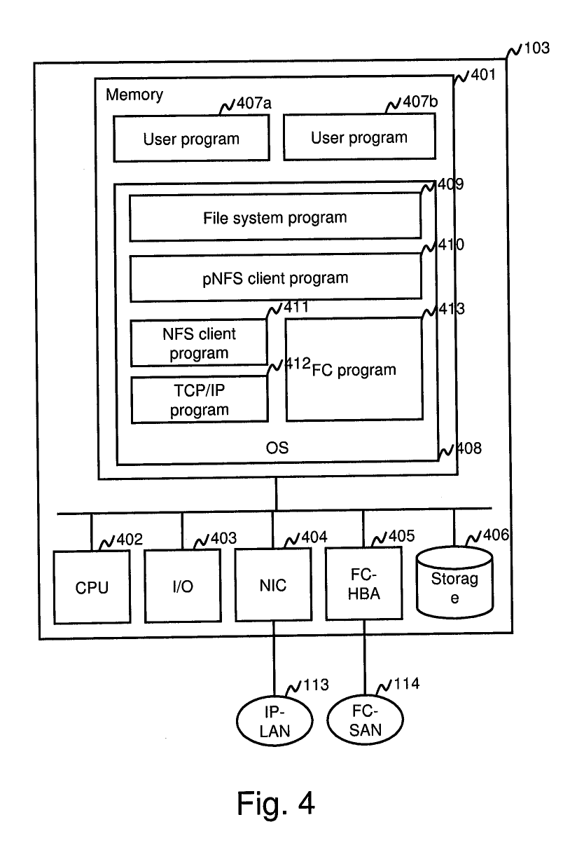

FIG. 4 shows an example of a pNFS client 103 or 104, which is equipped with FC-HBA 405 and is connected to FC-SAN 114. It has memory 401, CPU 402, I/O 403, NIC 404 connected to the IP-LAN 113, FC-HBA 405 connected to the FC-SAN 114, and internal storage 406. The memory 401 also executes user programs 407, OS 408, and, as OS-internal components, a file system program 409, a pNFS client program 410, a NFS client program 411, a TCP/IP program 412, and a FC program 413. These components work according to the protocol specified in the RFC 5661 and RFC 5663. The pNFS client program 410 sends a NFS message to the layout management server 105 to retrieve block layouts. It then sends FC commands to the block storages 111 and 112 to read and collect file data.

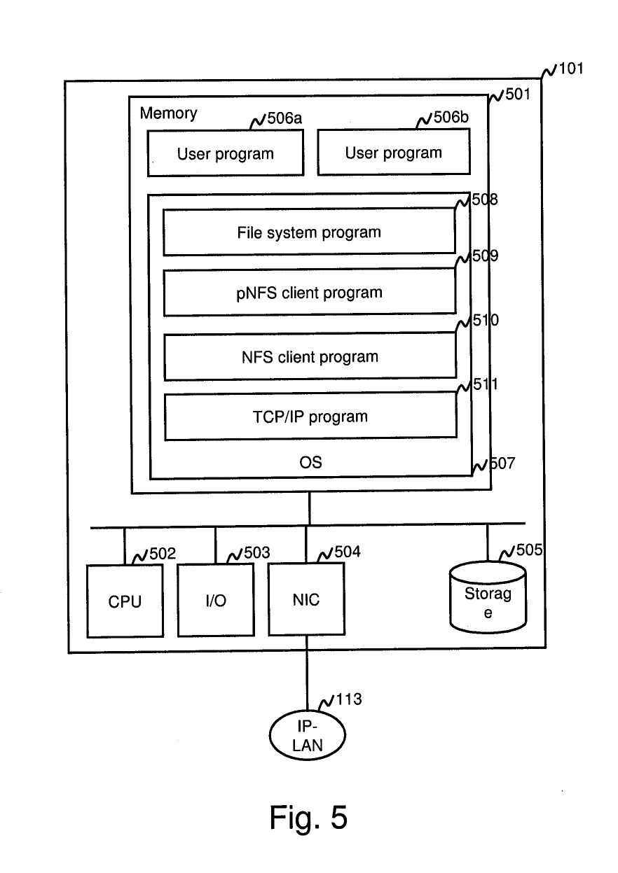

FIG. 5 shows an example of the pNFS client 101, which is equipped with NIC 504 that is connected to the IP-LAN 113 and does not have FC-HBA. It includes memory 501, CPU 502, I/O 503, NIC 504, and internal storage 505. These components are connected with each other via an internal bus. On the memory 501, the pNFS client 101 executes multiple user programs 506 and also an OS 507 including file system program 508, pNFS client program 509, NFS client program 510, and TCP/IP program 511. These components work according to the protocol specified in the RFC 5661. The pNFS client program 509 sends a NFS message to the layout management server 105 to retrieve file layouts. It then access NFS data servers 109 and 110.

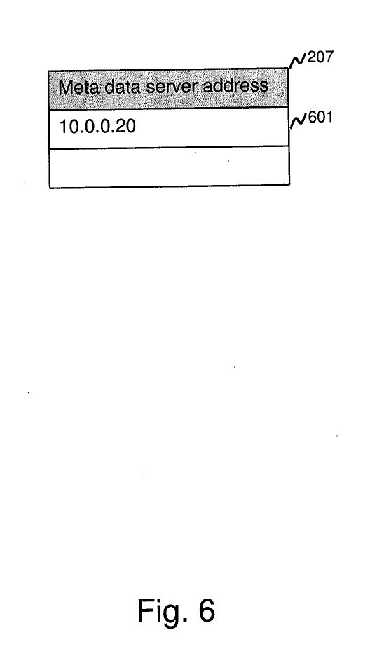

FIG. 6 shows an example of the meta-data server address information 207 of the gateway 106. It contains an address field that stores an IP address of the gateway 106. In this example, an entry 601 stores “10.0.0.20” as the IP address of the gateway 106.

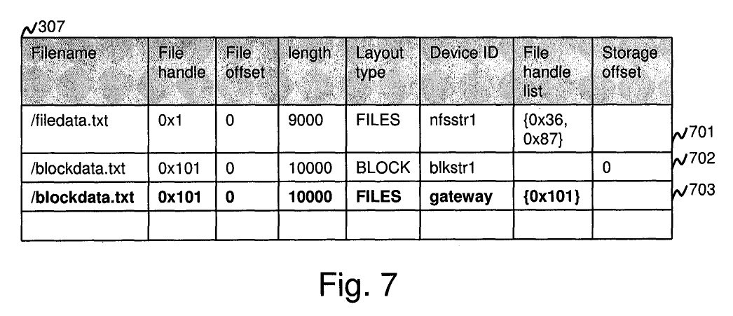

FIG. 7 shows an example of the layout information 307 of the layout management server 105. Each entry of the layout information 307 contains the fields of a file name, a file handle, file offset, file length, a layout type, a device ID, a list of file handles, and storage offset. In the example shown, the layout information 307 stores three entries of layout. The first entry 701 is about a file named “/filedata.txt” that has a file handle 0x1 and is stored in a set of file servers named “nfsstr1” with file layout. Each file server uses a file handle 0x36 and 0x87 to store the partial file data as each local file. The second entry 702 is about a file named “/blockdata.txt” that has a file handle 0x101 and is stored from the top of the volume named “blkstr1” with block layout. The third entry 703 is about the pseudo layout corresponding to the layout of the second entry 702. Its file handle is the same value as the one of the second entry 702. In contrast, its layout type is FILES and its device ID is the ID of the gateway 106. Further, 0x101, contents of its file handle list, is the same value as the file handle of the second entry 702.

The entry that has the gateway ID as its device ID is a characteristic of this invention. It enables the layout management server 105 to redirect the file request from the client without FC-HBA to the gateway 106. Further, the above consistency between the file handle of the block layout and the value of the file handle list of the pseudo file layout is another characteristic of this invention. It enables the gateway 106 to know the file requested by the client based on the file handle passed from the layout management server 105.

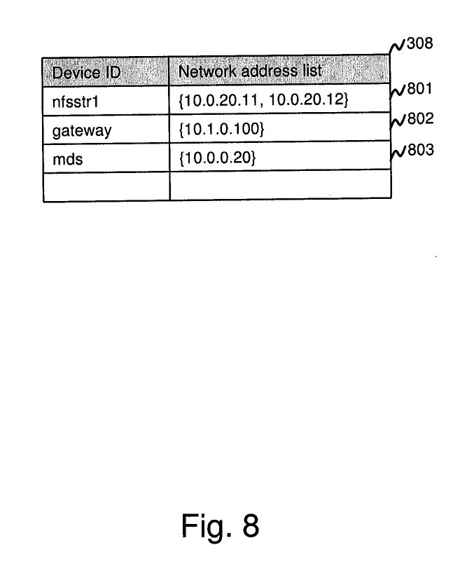

FIG. 8 shows an example of the file device information 308. This information describes managed NFS servers used to store file data in file layout. Each entry of this information is constructed with a set of device ID and a network address list. In this example, three NFS servers are listed. The first entry 801 is about the NFS file servers 107 and 108. The second entry 802 is about the gateway 106. The third entry 803 is about the layout management server 105.

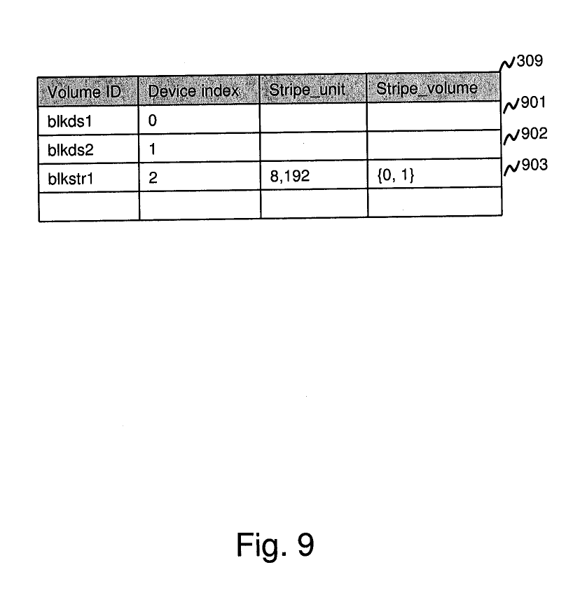

FIG. 9 shows an example of the block device information 309. This information describes managed block storages used to store file data in block layout. Each entry of this information is constructed with a set of a volume ID, a device index, size of striping, and a list of volumes. In this example, three volumes are listed. The first entry 901 and the second entry 902 are about simple volumes. In contrast, the third entry 903 is about a logical stripe volume. This logical volume is made from the two volumes that the first entry and the second entry indicate.

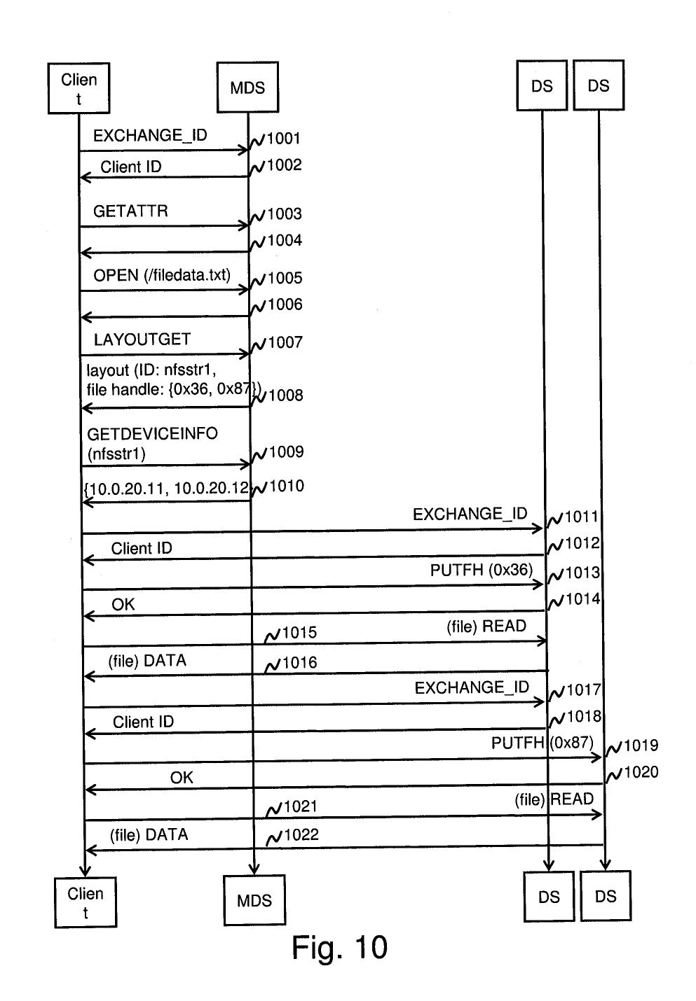

FIG. 10 shows an example of message sequence between a pNFS client, the layout management server, and NFS servers according to the first embodiment. This sequence complies with the pNFS protocol for file layout, which is specified in the prior art RFC 5661. First, the pNFS client 101 or 102 sends EXCHANGE_ID to the layout management server 105 in its NFS session to get a client ID (1001). If it gets the client ID (1002), it sends GETATTR to the layout management server 105 to check the supported layout type on the layout management server 105 (1003). If it receives a response indicating the desired layout type (1004), it sends an OPEN message including a file name to the layout management server 105 (1005). It then receives a response including a file handle of the designated file if the file is valid (1006). After the pNFS client 101 or 102 gets the file handle, it retrieves a file layout for the file. It sends LAYOUTGET message whose layout type is specified to file layout to the layout management server 105 (1007). As the response to this LAYOUTGET message, the pNFS client 101 or 102 receives a layout, which contains a set of a device ID and a file handle list (1008). The pNFS client 101 or 102 sends GETDEVICEINFO to the layout management server 105 (1009), and receives a list of network addresses of pNFS data servers corresponding to the device ID (1010). Finally, the pNFS client 101 or 102 sends EXCHANGE_ID to each data server 107 and 108 (1011, 1017) to get a client ID (1012, 1018) and sends PUTFH message to set the file handle (1013 & 1014, 1019 & 1020). Following the PUTFH operation, it sends READ messages (1015, 1021). As the response to these READ messages, it receives file data from data servers (1016, 1022). It then assembles the received file data to a file “filedata.txt.”

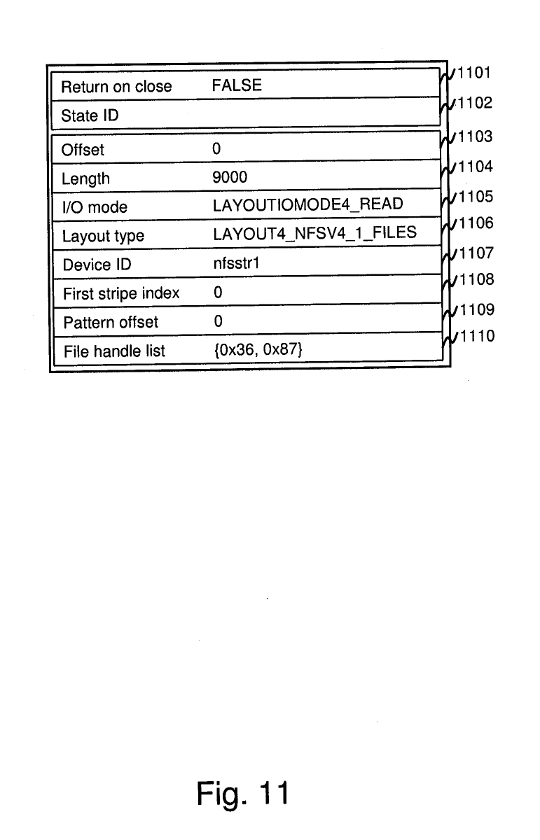

FIG. 11 shows an example of a layout message from the layout management server 105 (1008) as the response to the LAYOUTGET message from the pNFS client 101 or 102 (1007). The layout type field 1106 of this layout is set to LAYOUT4_NFSV4_1_FILES, which means the file layout. Also, the device ID field 1107 and the file handle list field 1110 are set to “nfsstr1” and {0x36, 0x87} respectively. The pNFS client 101 or 102 uses these file handles to read the two files on the NFS server 107 and 108 respectively. As seen in FIG. 11, the layout message includes entries for Return on close 1101, State ID 1102, Offset 1103, Length 1104, I/O mode 1105, Layout type 1106, Device ID 1107, First stripe index 1108, Pattern offset 1109, and File handle list 1110.

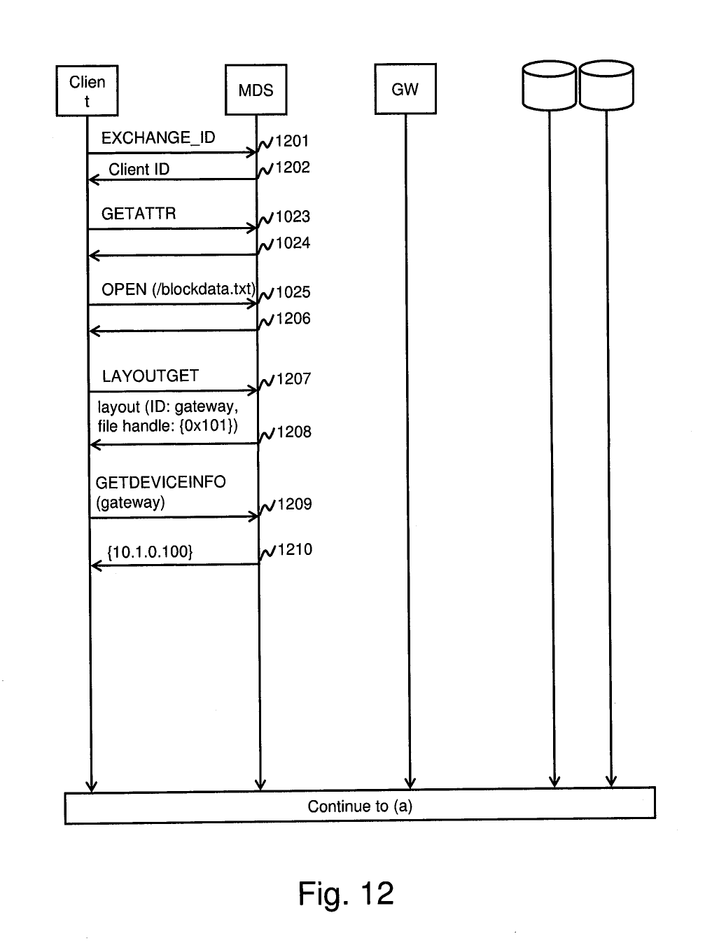

FIG. 12 shows an example of the message sequence according to the first embodiment of the present invention, including the layout management server 105 and the gateway 106. As the same with the sequence of 1001-1004 of FIG. 10, the pNFS client 101 or 102 sends EXCHANGE_ID (1201) and gets client ID from the layout management server 105 (1202). Then, it sends GETATTR (1203) and gets layout type supported by the layout management server 105 (1204). In this embodiment, the pNFS client 101 or 102 sends OPEN with filename “/blockdata.txt” to the layout management server 105 (1205), and updates the status with updated current file handle (1206). After the update of the current file handle, it sends LAYOUTGET message, whose layout type is set to file layout, to the layout management server 105 (1207). As the response to this LAYOUTGET message, the pNFS client 101 or 102 receives a layout, which contains a set of a device ID of the gateway 106 and a file handle list that contains 0x101 (1208). The pNFS client 101 or 102 sends GETDEVICEINFO to the layout management server 105 (1209), and receives a network-address list including only the address 10.1.0.100, which is an address of the gateway 106 (1210). This sequence, in which the layout management server 105 responds to the pNFS client 101 or 102 with a set of a device ID and a file handle corresponding to the pseudo layout entry 703, is a characteristic of the present invention according to the first embodiment.

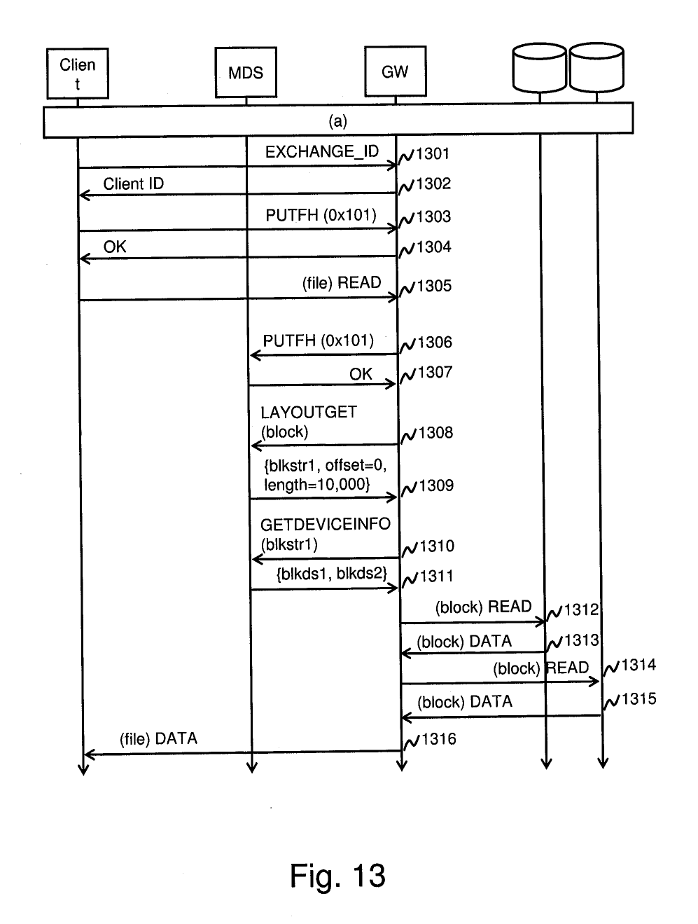

FIG. 13 shows an example of the message sequence which follows the message sequence of FIG. 12, according to the first embodiment. After the pNFS client 101 or 102 gets the network address 10.1.0.100 and file handle 0x101 of the gateway 106, the pNFS client 101 or 102 sends EXCHANGE_ID with a client capability flag of a NFS client to the gateway 106 (1301), and gets client ID as a NFS client (1302). It then sends PUTFH with the file handle 0x101 to the gateway 106 (1303, 1304), and sends READ message (1305).

Receiving the READ message from the pNFS client 101 or 102, the gateway 106 retrieves a network address of the layout management server 105 from the meta-data server address information 207. It then sends PUTFH message to the retrieved address 10.0.0.20 (1306, 1307). This PUTFH message includes the file handle 0x101, which was provided by the PUTFH message from the pNFS client 101 or 102 at the sequence 1303. After the change of file handle, the gateway 106 sends to the layout management server 105 a LAYOUTGET message whose layout type is set to block layout (1308). It then receives a layout from the layout management server 105 (1309). This layout contains a device ID “blkstr1” which indicates a logical block volume made from physical block storage 111 and 112. It also contains an offset and length of file data in the logical volume “blkstr1.” In order to check the volume topology of the designated volume “blkstr1,” the gateway 106 sends GETDEVICE INFO message to the layout management server 105 (1310). It then receives a list of two volume IDs “blkds1” and “blkds2,” which indicates the physical block storage 111 and 112 (1311).

Extracting the volumes, the gateway 106 sends two FC READ commands to the physical block storage 111 and 112 respectively (1312, 1314) and receives file data from these block storages in parallel (1313, 1315). It then assembles the received file data to a file. Finally, the gateway 106 sends the assembled file data to the pNFS client 101 or 102 as the response to the READ message in sequence 1305 (1316).

These message sequences, especially one between the layout management server 105 and the gateway 106, are the essential part of the first embodiment of the present invention. It realizes conversion from file access to block access in the pNFS distributed file system.

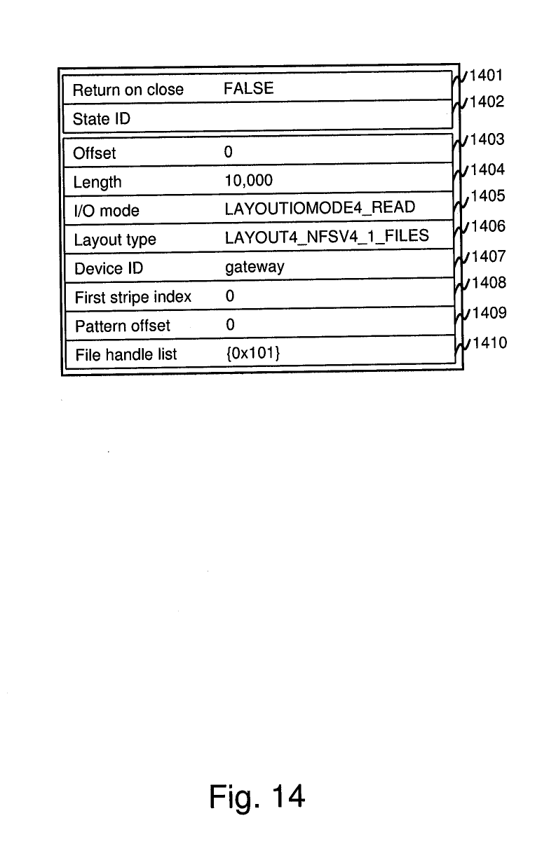

FIG. 14 shows an example of a layout sent to the pNFS client 101 or 102 from the layout management server at the sequence 1208. The format of this layout data complies with the specification in the RFC 5661. Its layout type field 1406 is set to LAYOUT4_NFSV4_1_FILES which indicates file layout. Its device ID field 1407 is set to “gateway” which indicates the gateway 106. Its file handle list field 1410 is set to {0x101} which is a file handle of the pseudo layout entry 703. As seen in FIG. 14, the layout message includes entries for Return on close 1401, State ID 1402, Offset 1403, Length 1404, I/O mode 1405, Layout type 1406, Device ID 1407, First stripe index 1408, Pattern offset 1409, and File handle list 1410.

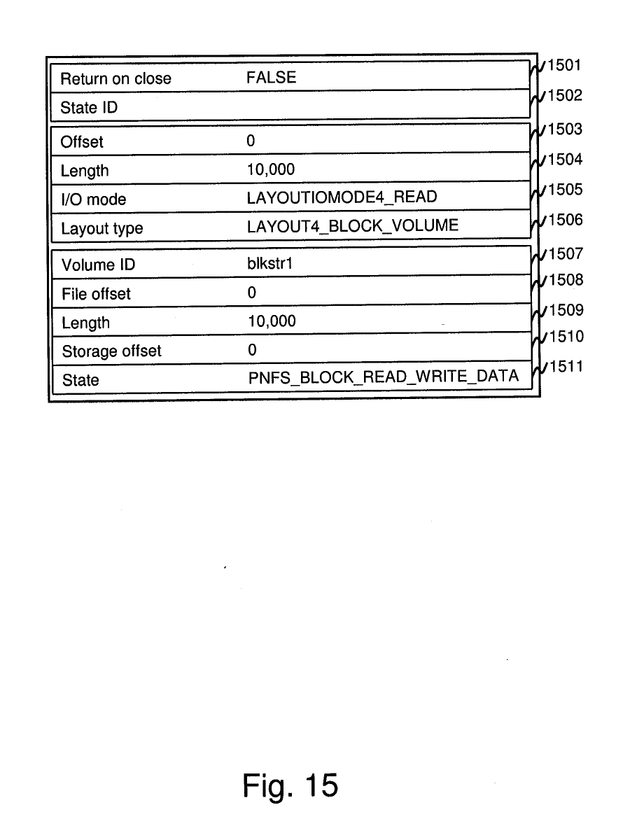

FIG. 15 shows an example of a layout sent to the gateway 106 from the layout management server 105 at the sequence 1307. The format of this layout data complies with RFC 5663. Its layout type field 1506 is set to LAYOUT4_BLOCK_VOLUME which indicates block layout. Its volume ID field 1507 is set to “blkstr1” which indicates the logical volume made from two physical block storages 111 and 112. Its length field 1509 is set to 10,000 which is the length of the designated file. As seen in FIG. 15, the layout message includes entries for Return on close 1501, State ID 1502, Offset 1503, Length 1504, I/O mode 1505, Layout type 1506, Volume ID 1507, First offset 1508, Length 1509, Storage offset 1510, and State 1511.

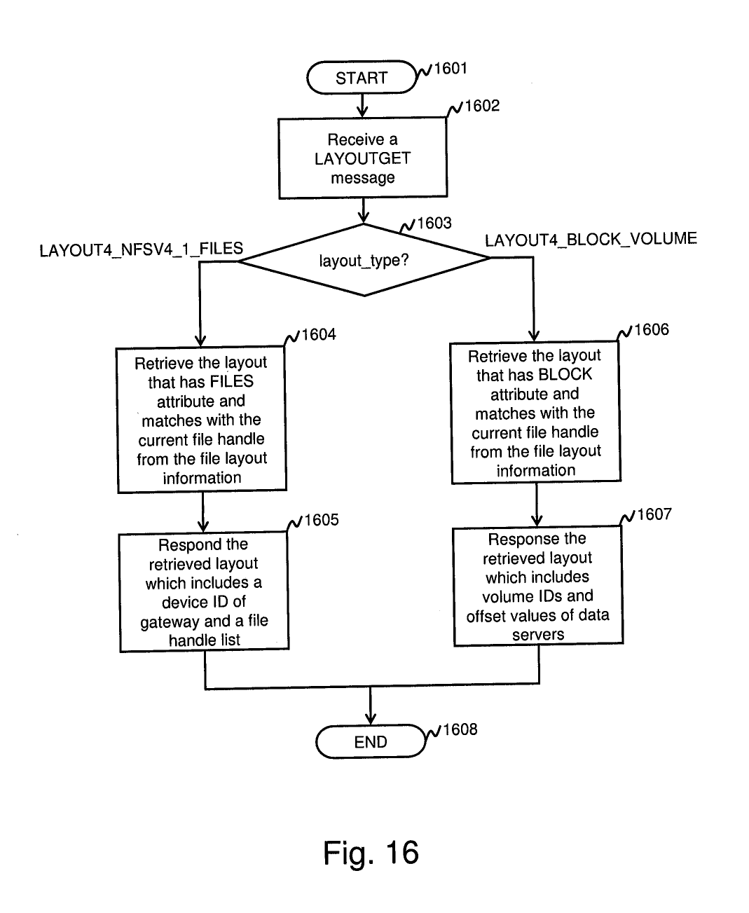

FIG. 16 shows an example of a flow diagram illustrating the process of the LAYOUTGET message process program 309 of the layout management server 105. The program 309 is invoked by the pNFS meta-data server program 313 when the layout management server 105 receives a LAYOUTGET message, and processes the LAYOUTGET message as follows.

The program states at step 1601. In step 1602, the LAYOUTGET message process program 309 receives a LAYOUTGET message and extracts the control parameters encoded in its fields. It then checks the value of layout_type field of the LAYOUTGET message (1603). If the field is set to LAYOUT4_NFSV4_1_FILES, it retrieves the entry whose file handle is the same as the current file handle and also whose layout type is set to FILES from the layout information 307 (1604). It then responds to the retrieved layout which includes a device ID of the gateway 106 and the file handle list including the current file handle (1605). If the field is set to LAYOUT4_BLOCK_VOLUME, it retrieves the entry whose file handle is the same as the current file handle and also whose layout type is set to BLOCK from the layout information 307 (1606). It then responds to the retrieved layout (1607). This layout includes a volume ID of a logical volume made from the physical storage 111 and 112. It also includes an offset value for file data in the logical volume. The LAYOUTGET message process program 309 ends at step 1608.

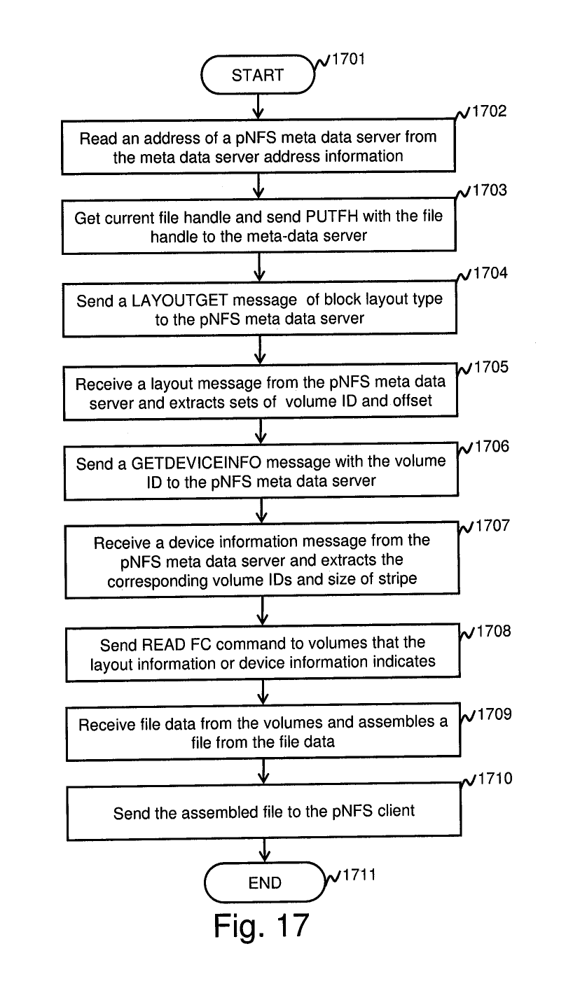

FIG. 17 shows an example of a flow diagram illustrating the process of the pNFS file request forward program 208 of the gateway 106. The program 208 is invoked by the NFS server program 211 when the gateway 106 receives a NFS READ message from the pNFS client 101 or 102, and processes the NFS READ message as follows.

The program starts at step 1701. In step 1702, the pNFS file request forward program 208 reads an address of the layout management server 105 from the meta-data server address information 207. It also gets the current file handle from the NFS server program 211, and then sends a PUTFH message that contains the retrieved current file handle to the layout management server 105 (1703). After the setting of the file handle, It then sends a LAYOUTGET message to the layout management server 105 (1704). This LAYOUTGET message is set its layout type to block layout. As the response to the LAYOUTGET message, the pNFS file request forward program 208 receives a layout, and extracts sets of a volume ID and offset (1705). It then sends a GETDEVICEINFO message with the volume ID extracted from the layout in the above sequence to the layout management server 105 (1706). As the response to the GETDEVICE INFO message, it then receives volume IDs of the physical block storage 111 and 112 and size of stripe (1707). It sends FC READ commands to the volumes indicated by the received volume IDs (1708), receives file data from the volumes, and assembles a file from the file data (1709). Finally, it sends the assembled file to the pNFS client 101 or 102 (1710). The program ends at step 1711.

### Second Embodiment

The second embodiment of the present invention provides the gateway that acts as a pNFS client. Other pNFS clients without FC-HBA use the gateway to read a file that is stored with block layout in block storages. This embodiment enables to share the FC-HBA of a pNFS client. Therefore, in order to enable all pNFS clients to reach files stored in block storages, the users do not need to place additional gateway hardware into their shared file systems. It has the effect to keeping their capital expenditures low.

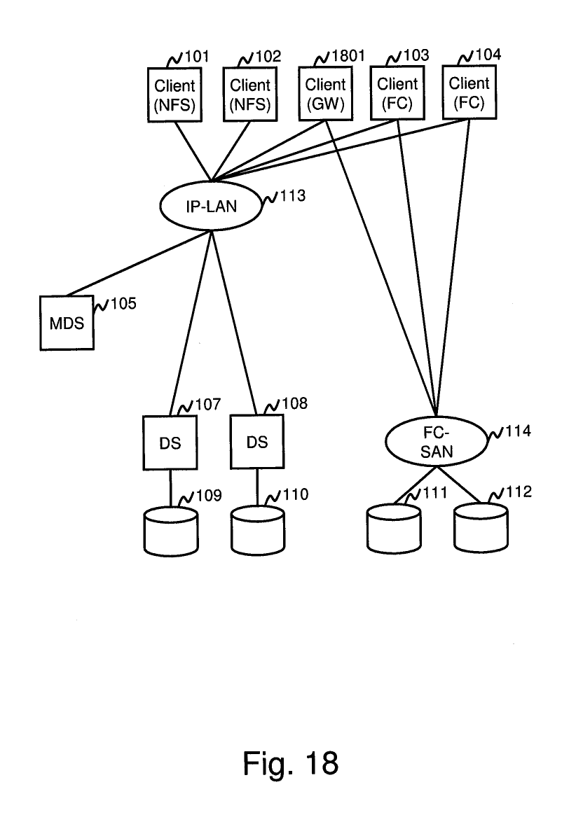

FIG. 18 shows an example of a network file system including a novel layout management server 105 and a novel gateway 1801 embedded in a pNFS client according to the second embodiment. This system also includes multiple NFS clients 101 and 102, and multiple clients 103 and 104 equipped with both of NIC and FC-HBA. These clients 101-104, the layout management server 105, and the gateway 106 are connected with each other via IP-LAN 113. The system also includes data servers 107 and 108 that support NFS access via the IP-LAN 113 to get file data directly from attached storage 109 and 110 respectively. It also includes multiple block storages 111 and 112 connected to the clients 103, 104, and the gateway 106 via FC-SAN 114.

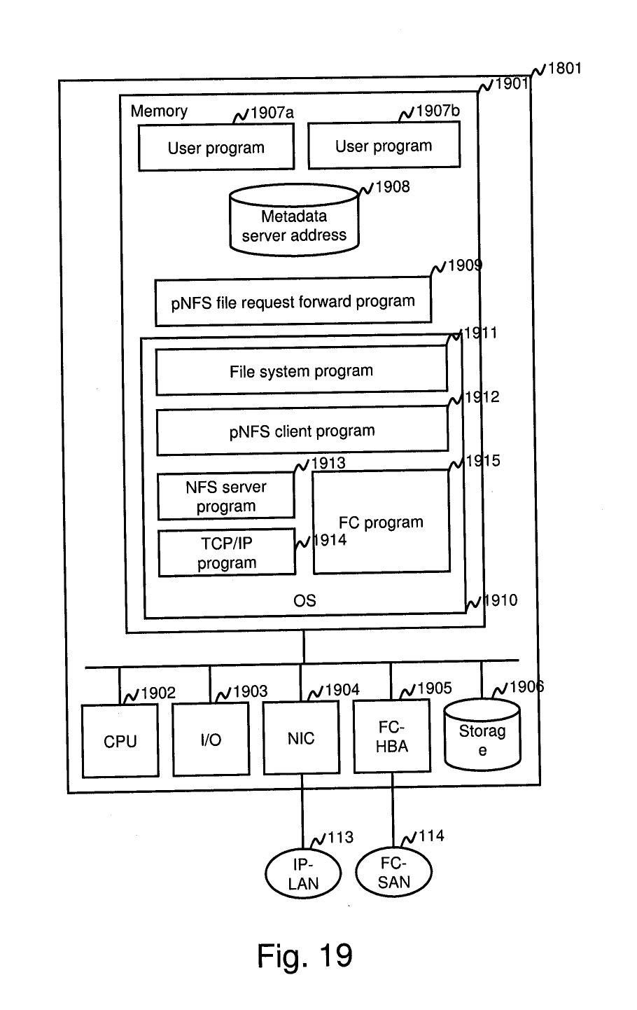

FIG. 19 shows an example of the gateway 1801 of FIG. 18. It has memory 1901, CPU 1902, I/O 1903, NIC 1904 connected to the IP-LAN 113, FC-HBA 1905 connected to the FC-SAN 114, and internal storage 1906. These components are connected with each other via an internal bus. The memory 1901 stores meta-data server address information 1908 and it stores multiple user programs 1907 and a pNFS file request forward program 1909 to be executed by the CPU 1902. The meta-data server address information 1908 stores the IP addresses of the layout management server 105. The pNFS file request forward program 1909 receives NFS READ operation request from the client 101 or 102, and based on the request, it retrieves a block layout from layout management server 105 and collects file data from block storages 111 and 112. It transfers a file made from the collected file data to the client 101 or 102. This metadata server address information 1908 and this pNFS file request forward program 1909 have the same structure and functions with the metadata server address information 207 and pNFS file request forward program 208 of the first embodiment shown in FIG. 2. Therefore, essential points of the second embodiment are the same as those of the first embodiment. The gateway 1801 also executes an OS 1910 including a file system program 1911, a pNFS client program 1912, a NFS server program 1913, a TCP/IP program 1914, and a FC program 1915, which are existing technologies.

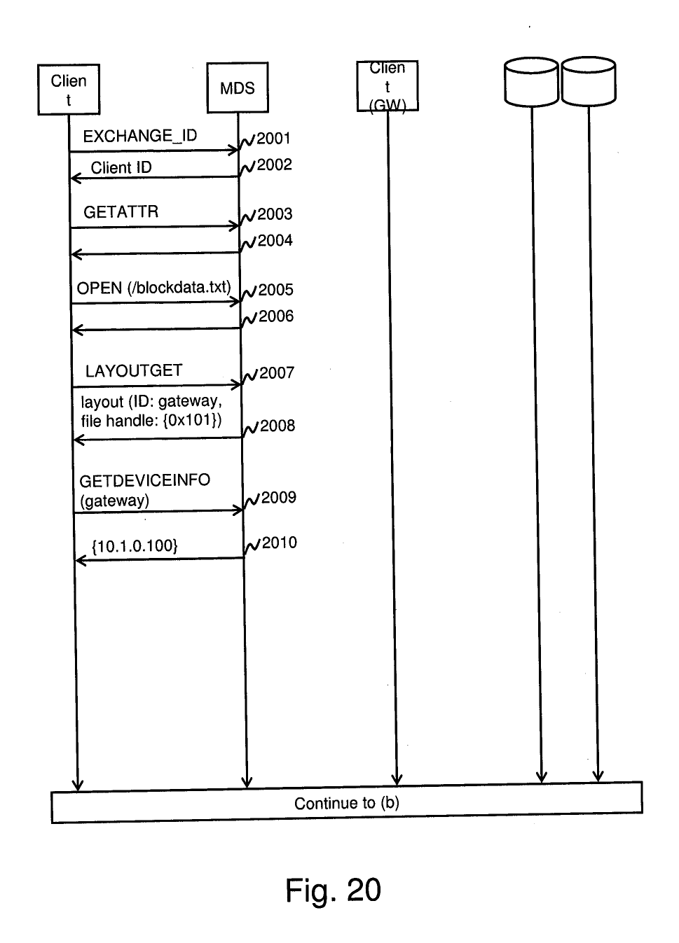

FIG. 20 shows an example of the message sequence according to the second embodiment of the present invention, including the layout management server 105 and the gateway 1801. This message sequence is no different from the one shown in the first embodiment of FIG. 12. The pNFS client 101 or 102 sends EXCHANGE_ID (2001) and gets client ID from the layout management server 105 (2002). Then, it sends GETATTR (2003) and gets layout type supported by the layout management server 105 (2004). The pNFS client 101 or 102 sends OPEN with filename “/blockdata.txt” to the layout management server 105 (2005), and updates the status with updated current file handle (2006). After the update of the current file handle, it sends LAYOUTGET message, whose layout type is set to file layout, to the layout management server 105 (2007). As the response to this LAYOUTGET message, the pNFS client 101 or 102 receives a layout, which contains a set of a device ID of the gateway 1801 and a file handle list that contains 0x101 (2008). The pNFS client 101 or 102 sends GETDEVICEINFO to the layout management server 105 (2009), and receives a network-address list including only the address 10.1.0.100, which is an address of the gateway 1801 (2010).

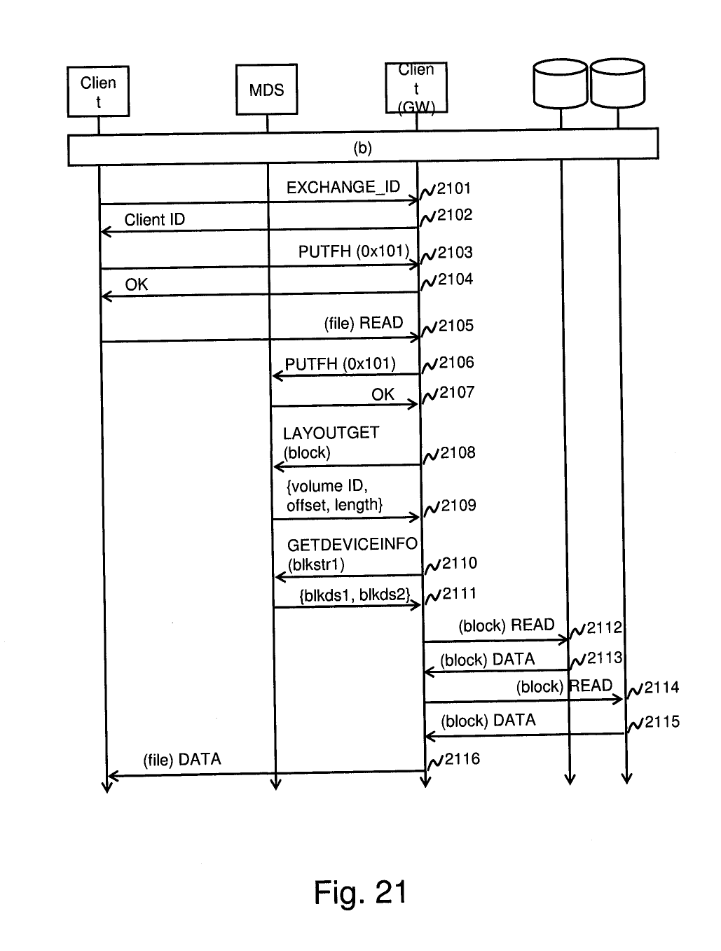

FIG. 21 shows an example of the message sequence which follows the message sequence of FIG. 20. This message sequence is no different from the one shown in the first embodiment of FIG. 13, except that the gateway 1801 acts as both a gateway and a pNFS client. After the pNFS client 101 or 102 gets the network address 10.1.0.100 and file handle 0x101 of the gateway 1801, the pNFS client 101 or 102 sends EXCHANGE_ID with a client capability flag of a NFS client to the gateway 1801 (2101), and gets client ID as a NFS client (2102). It then sends PUTFH with the file handle 0x101 to the gateway 1801 (2103, 2104), and sends READ message (2105). Receiving the READ message from the pNFS client 101 or 102, the gateway 1801 retrieves a network address of the layout management server 105 from the meta-data server address information 1908. It then sends PUTFH message to the retrieved address 10.0.0.20 (2106, 2107). This PUTFH message includes the file handle 0x101, which was provided by the PUTFH message from the pNFS client 101 or 102 at the sequence 2103. After the change of file handle, the gateway 1801 sends to the layout management server 105 a LAYOUTGET message whose layout type is set to block layout (2108). It then receives a layout from the layout management server 105 (2109). This layout contains a device ID “blkstr1” which indicates a logical block volume made from physical block storage 111 and 112. It also contains an offset and length of file data in the logical volume “blkstr1.” In order to check volume topology of the designated volume “blkstr1,” the gateway 1801 sends GETDEVICE INFO message to the layout management server 105 (2110). It then receives a list of two volume IDs “blkds1” and “blkds2,” which indicates the physical block storage 111 and 112 (2111).

Extracting the volumes, the gateway 1801 sends two FC READ command to the physical block storage 111 and 112 respectively (2112, 2114) and receives file data from these block storages in parallel (2113, 2115). It then assembles the received file data to a file. Finally, the gateway 1801 sends the assembled file data to the pNFS client 101 or 102 as the response to the READ message in sequence 2105 (2116).

### Third Embodiment

The third embodiment of the present invention provides a server that acts as both of the layout management server and the gateway. When pNFS clients with FC-HBA request a block layout of a file in block storages, this combined server responds with volume IDs of the block storages. On the other hand, when pNFS clients without FC-HBA request a file layout of a file in block storages, this combined server reads the file via FC-SAN by itself and acts as a pNFS data server.

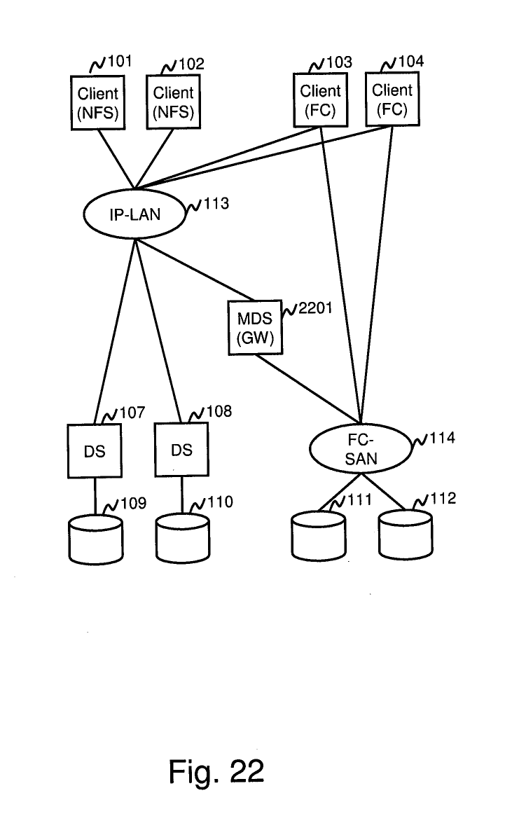

FIG. 22 shows an example of a network file system including a novel layout management server 2201 that acts as the novel gateway according to the third embodiment. This system also includes multiple NFS clients 101 and 102, multiple clients 103 and 104 equipped with both of NIC and FC-HBA. These clients 101-104 and the layout management server 2201 are connected with each other via IP-LAN 113. The system also includes data servers 107 and 108 that support NFS access via IP-LAN 113 to get file data directly from attached storage 109 and 110 respectively. It also includes multiple block storages 111 and 112 connected to the clients 103, 104, and the layout management server 2201 via FC-SAN 114.

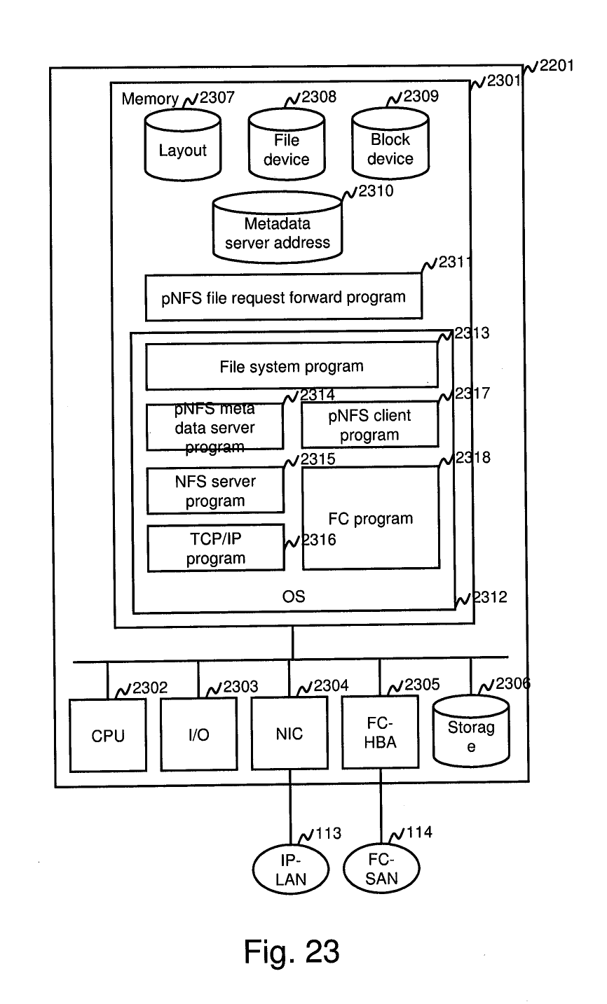

FIG. 23 shows an example of the combined server 2201 of FIG. 22. It has memory 2301, CPU 2302, I/O 2303, NIC 2304 connected to the IP-LAN 113, FC-HBA 2305 connected to the FC-SAN 114, and internal storage 2306. These components are connected with each other via an internal bus. The memory 2301 stores layout information 2307, file device information 2308, block device information 2309, and meta-data server address information 2310, and it stores a pNFS file request forward program 2311 to be executed by the CPU 2302. The meta-data server address information 2310 stores the IP addresses of the combined server itself. The pNFS file request forward program 2311 receives NFS READ operation request from the client 101 or 102, and based on the request, it retrieves a block layout from layout information 2307 and collect file data from block storages 111 and 112. It transfers a file made from the collected file data to the client 101 or 102.

The layout information 2307, file device information 2308, block device information 2309 have the same structure as, respectively, the layout information 306, file device information 307, block device information 308 of the layout management server 105 in the first embodiment of FIG. 3. The metadata server address information 2310 and the pNFS file request forward program 2311 in this embodiment have the same structure and functions as the metadata server address information 207 and pNFS file request forward program 208 of the gateway in the first embodiment of FIG. 2. Therefore, essential points of the third embodiment are the same as those of the first embodiment.

The gateway 2201 also executes an OS 2312 including a file system program 2313, a pNFS meta-data server program 2314, a NFS server program 2315, a TCP/IP program 2316, a pNFS client program 2317, and a FC program 2318, which are existing technologies.

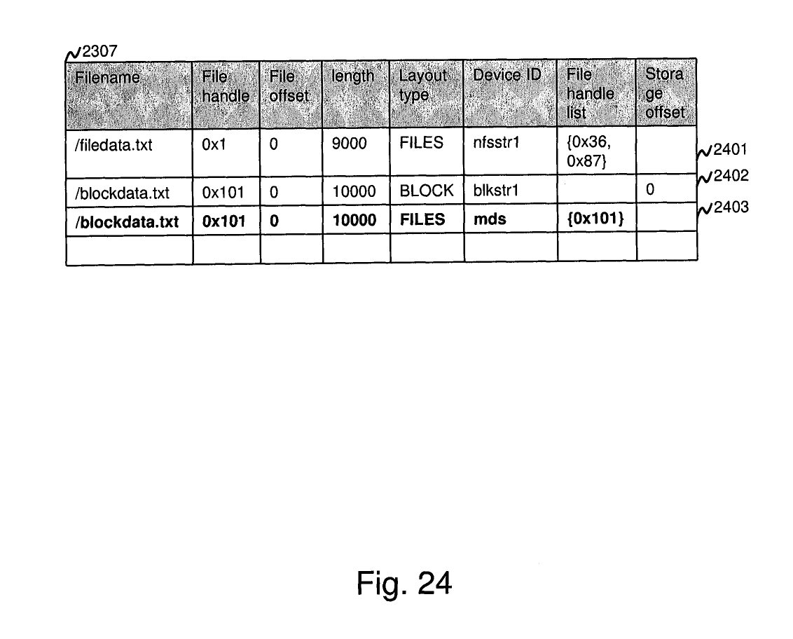

FIG. 24 shows an example of the layout information 2307 of the combined server 2201 according to the third embodiment. This layout information has the same structure as the layout information 307 in the first embodiment of FIG. 7. In this example, the layout information 2307 stores three entries of layout. The first entry 2401 is about a file named “/filedata.txt” that has a file handle 0x1 and is stored in a set of file servers named “nfsstr1” with file layout. Each file server uses a file handle 0x36 and 0x87 to store the partial file data as each local file. The second entry 2402 is about a file named “/blockdata.txt” that has a file handle 0x101 and is stored from the top of the volume named “blkstr1” with block layout. The third entry 2403 is about the pseudo layout corresponding to the layout of the second entry 2402. Its file handle is the same value as the one in the second entry 2402. In contrast, its layout type is FILES and its device ID “mds” is the ID of the combined server 2201. Further, 0x101, contents of its file handle list, is the same value as the file handle of the second entry 2402.

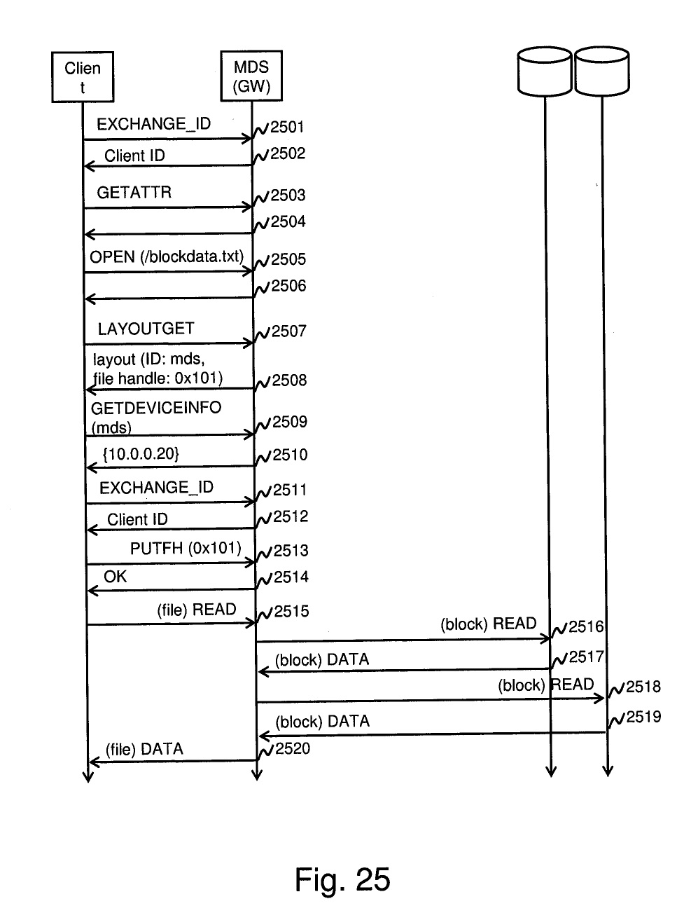

FIG. 25 shows an example of the message sequence according to the third embodiment of the present invention, including the combined server 2201. A former part of this message sequence is no different from the one shown in the first embodiment of FIG. 12. The pNFS client 101 or 102 sends EXCHANGE_ID (2501) and gets client ID from the combined server 2201 (2502). Then, it sends GETATTR (2503) and gets layout type supported by the combined server 2201 (2504). The pNFS client 101 or 102 sends OPEN with filename “/blockdata.txt” to the combined server 2201 (2505), and updates the status with updated current file handle (2506). After the update of the current file handle, it sends LAYOUTGET message, whose layout type is set to file layout, to the combined server 2201 (2507). As the response to this LAYOUTGET message, the pNFS client 101 or 102 receives a layout, which contains a set of a device ID “mds” which is the ID of the combined server 2201 and a file handle list that contains 0x101 (2508). The pNFS client 101 or 102 sends GETDEVICEINFO to the combined server 2201 (2509), and receives a network-address list including only the address 10.0.0.20, which is an address of the combined server 2201 (2510). After getting the network address and the file handle of the combined server 2201, the pNFS client 101 or 102 sends a EXCHANGE_ID message that indicates NFS access (2511) to get a client ID from the combined server 2201 (2512). It then sends a PUTFH with the file handle 0x101 included in the layout received at the sequence 2508 (2511, 2512). It then sends a NFS READ to the combined server 2201 (2513 & 2514). Receiving the NFS READ message from the pNFS client 101 or 102 (2515), the combined server 2201 retrieves the layout corresponding to the current file handle for the pNFS client 101 or 102 from the layout information 2307. It then extracts a volume ID from the retrieved layout. It also retrieves volume IDs of the physical block storages 111 and 112 by the extracted volume ID.

By using the retrieved volume IDs, the combined server 2201 sends FC READ commands to the volumes (2516, 2518). It then receives file data from the volumes (2517, 2519). From the received file data, the combined server 2201 assembles a file. Finally, the combined server 2201 sends the assembled file to the pNFS client 101 or 102 as the response to the NFS READ message at the sequence 2515 (2520).

Of course, the system configurations illustrated in FIGS. 1, 18, and 22 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for transferring shared files to clients. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A system comprising:
a plurality of first nodes having an interface to receive via fibre channel protocol;
a plurality of second nodes having an interface to receive via file access protocol;
a layout management server which upon receiving from a client a write request containing file data to be written to any of the plurality of first and second nodes, returns to the client, information of location of data for the write request; and
a gateway coupled to the plurality of first nodes and second nodes;
wherein the gateway converts access from file access protocol to fibre channel protocol so that a client issuing write requests in file access protocol is able to write file data to the plurality of first nodes via the gateway.

2. The system according to claim 1,
wherein the gateway, in response to receiving an access to the plurality of first nodes by file access protocol, sends a request for layout information to the layout management server, and converts the access from file access protocol to fiber channel protocol using the layout information from the layout management server.

3. The system according to claim 2,
wherein the layout information includes, for each layout regarding a file, a file name, a file handle, a layout type, and an identification of a target device.

4. The system according to claim 3,
wherein the layout management server sends the layout information to the gateway in response to the request from the gateway, and
wherein the target device is the gateway indicating access to the plurality of first nodes by file access protocol, and the gateway creates layout information for the access to the plurality of first nodes by file access protocol.

5. The system according to claim 3,
wherein access to the plurality of first nodes has an original BLOCK layout which includes a BLOCK layout type and identification of at least one first node as the target device,
wherein the layout management server creates a pseudo FILE layout having the same file handle as the original BLOCK layout, a FILES layout type, and identification of the gateway as the target device, thereby indicating a conversion from file access protocol to fibre channel protocol to access the target device of the original block layout via the gateway, and
wherein the layout information includes both the original BLOCK layout and the pseudo FILE layout.

6. A system comprising:
a plurality of first nodes having an interface to receive via fibre channel protocol;
a plurality of second nodes having an interface to receive via file access protocol; and
a layout management server coupled to the plurality of first nodes and second nodes, and which, upon receiving from a client a write request containing file data to be written to any of the plurality of first and second nodes, returns to the client, information of location of data for the write request;
wherein the layout management server converts access from file access protocol to fibre channel protocol so that a client issuing write requests in file access protocol is able to write file data to the plurality of first nodes via the layout management server.

7. The system according to claim 6,
wherein the layout management server converts the access from file access protocol to fiber channel protocol using layout information, and
wherein the layout information includes, for each layout regarding a file, a file name, a file handle, a layout type, and an identification of a target device.

8. The system according to claim 7,
wherein the target device is set as the layout management server indicating access to the plurality of first nodes by file access protocol.

9. The system according to claim 7,
wherein access to the plurality of first nodes has an original BLOCK layout which includes a BLOCK layout type and identification of at least one first node as the target device,
wherein the layout management server creates a pseudo FILE layout having the same file handle as the original BLOCK layout, a FILES layout type, and identification of the gateway as the target device, thereby indicating a conversion from file access protocol to fibre channel protocol to access the target device of the original block layout via the gateway, and
wherein the layout information includes both the original BLOCK layout and the pseudo FILE layout.

10. A system comprising:
a plurality of host computers;
a plurality of first nodes having an interface to receive via fibre channel protocol;
a plurality of second nodes having an interface to receive via file access protocol; and
a layout management server which upon receiving from any one of the host computers a write request containing file data to be written to any of the plurality of first and second nodes, returns to the one host computer, information of location of data for the write request;
wherein a first host computer of the plurality of host computer converts access from file access protocol to fibre channel protocol so that a second host computer of the plurality of host computers issuing write requests in file access protocol is able to write file data to the plurality of first nodes via the first host computer.

11. The system according to claim 10,
wherein the first host computer, in response to receiving an access to the plurality of first nodes by file access protocol, sends a request for layout information to the layout management server, and converts the access from file access protocol to fiber channel protocol using the layout information from the layout management server.

12. The system according to claim 11,
wherein the layout information includes, for each layout regarding a file, a file name, a file handle, a layout type, and an identification of a target device.

13. The system according to claim 12,
wherein the layout management server sends the layout information to the first host computer in response to the request from the first host computer, and
wherein the target device is the first host computer indicating access to the plurality of first nodes by file access protocol, and the first host computer creates layout information for the access to the plurality of first nodes by file access protocol.

14. The system according to claim 12,
wherein access to the plurality of first nodes has an original BLOCK layout which includes a BLOCK layout type and identification of at least one first node as the target device,
wherein the layout management server creates a pseudo FILE layout having the same file handle as the original BLOCK layout, a FILES layout type, and identification of the first host computer as the target device, thereby indicating a conversion from file access protocol to fibre channel protocol to access the target device of the original block layout via the first host computer, and
wherein the layout information includes both the original BLOCK layout and the pseudo FILE layout.

14. The system according to claim 12,
wherein the second host computer is incapable of access via fibre channel protocol.
